(19) United States
(12) Patent Application Publication
(10) Pub. No.: US 2007/0045392 A1
(43) Pub. Date: Mar. 1, 2007

(54) Modular keyboard system

(76) Inventors: John E. Youens, Magnolia, TX (US); Cynthia J. Purvis, The Woodlands, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/215,564

(22) Filed: Aug. 29, 2005

(51) Int. Cl. G06C 7/02

(52) U.S. Cl. 235/145 R

(57) ABSTRACT

A modular keyboard system includes a first module having a left end and a right end, and a second module configured to be coupled rigidly to at least one of the left and right ends of the first module.

### FIELD OF THE INVENTION

This invention relates generally to keyboards, and more specifically to techniques for making keyboards user-configurable.

### BACKGROUND

Many computer systems in use today employ a keyboard as a primary user-input device. Keyboards for such systems typically provide a field of alphanumeric and punctuation keys and one or more additional fields of special keys such as function keys, cursor positioning keys and/or a numeric keypad. By convention, the cursor positioning keys and the numeric keypad are located on the keyboard to the right of the alphanumeric and punctuation keys.

### BRIEF DESCRIPTION OF THE DRAWINGS

FIG. 1 is a front oblique view of a keyboard module and a detachable module according to a preferred embodiment of the invention.

FIGS. 2A and 2B are assembly views illustrating a profile of one end of the keyboard module of FIG. 1 and a corresponding section of one end of the detachable module of FIG. 1.

FIG. 3 is a front oblique view illustrating a variety of detachable modules configured for use with the keyboard module of FIG. 1 according to additional preferred embodiments of the invention.

FIG. 4 is a schematic view of an example computer system incorporating a modular keyboard system according to a preferred embodiment of the invention.

FIG. 5 is rear oblique view of the keyboard module and detachable module of FIG. 1 illustrating cabling features according to a preferred embodiment of the invention.

### DETAILED DESCRIPTION OF THE PREFERRED EMBODIMENTS

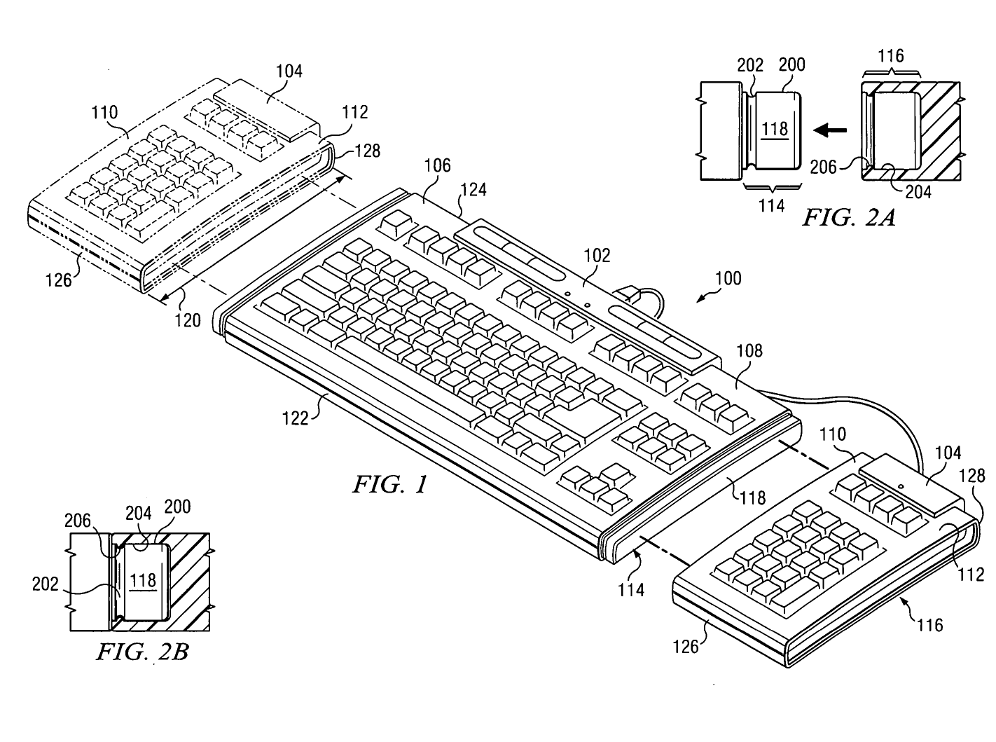

For a variety of reasons, different users may have different preferences regarding which key fields they want on a keyboard and where the key fields should be located on the keyboard. For example, a right-handed user who does not frequently use the numeric keypad might prefer to omit the numeric keypad from the keyboard or to locate it to the left of the alphanumeric and punctuation keys. Such an arrangement may be ergonomically advantageous for the right-handed user, as it tends to reduce the amount of shoulder abduction that occurs when the user reaches from the alphanumeric keys to the mouse. On the other hand, a left-handed user might prefer just the opposite arrangement. A modular keyboard system such as keyboard system 100 shown in FIG. 1 provides significant flexibility in this regard.

Keyboard system 100 includes a keyboard module 102 and a detachable module 104: Keyboard module 102 has a left end 106 and a right end 108. Detachable module 104 has a left end 110 and a right end 112. Detachable module 104 is configured to be coupled rigidly either to left end 106 of keyboard module 102 or to right end 108 of keyboard module 102.

In the embodiment shown, keyboard module 102 includes a male coupling feature 114 at its left and right ends 106, 108, and detachable module 104 includes a corresponding female coupling feature 116 at its left and right ends 110, 112. In alternative embodiments, either of coupling features 114, 116 may appear on only one end of the respective module, and coupling features 114, 116 may be reversed such that the male coupling feature appears on module 104 while the female coupling feature appears on module 102. Indeed, any combination of locations and genders may be employed with regard to coupling features 114, 116.

Coupling features 114, 116 may be constructed in a variety of ways. In the illustrated embodiment, coupling feature 114 includes a boss 118 having a head 200 and a neck 202 (see FIGS. 2A and 2B). Coupling feature 116 includes a void 204 for receiving head 200 and a protrusion 206 for engaging neck 202 as shown in FIG. 2B. FIG. 1 illustrates a length 120 extending from the front 122 to the back 124 of keyboard module 102 and from the front 126 to the back 128 of detachable module 104. In the illustrated embodiment, coupling features 114 and 116 extend along substantially the entirety of length 120. In alternative embodiments, keyboard module 102 and detachable module 104 need not have the same length from front to back. Moreover, coupling features 114, 116 need not extend along the entire length from front to back of their respective modules. For example, the lengths of coupling features 114, 116 may be shortened, and several male and female pairs of coupling features may be positioned along length 120 in lieu of the one long pair illustrated.

In a preferred embodiment, coupling feature 116 may be operable to deform elastically as protrusion 206 passes over boss 118 during engagement and disengagement of detachable module 104 with keyboard module 102. One technique for achieving this is to form coupling feature 116 from molded plastic. Another technique is to provide either boss 118 or protrusion 206, or both, with a beveled or rounded surface as shown, to facilitate engagement and disengagement between the two members.

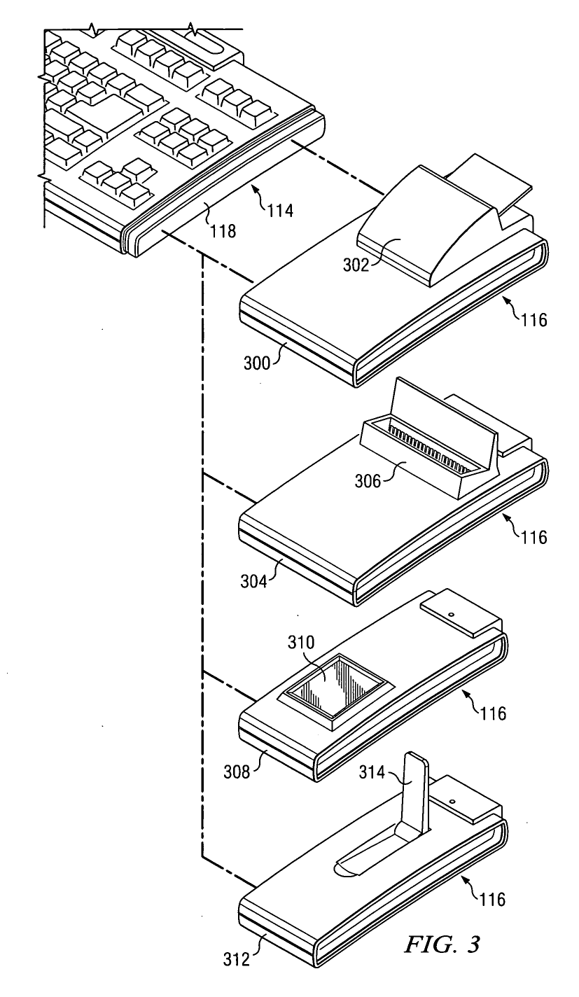

Keyboard module 102 and detachable module 104 may each take a wide variety of forms including not only those illustrated in FIGS. 1 and 3, but also other forms that will fall within the abilities of persons having ordinary skill in the art after having had access to the teachings of this disclosure. For example, detachable module 104 may include a numeric keypad as suggested in FIG. 1. Alternatively, a module 300 may be provided that includes a smart card interface 302 for reading or writing media such as smart cards, flash memory cards or other memory or information processing devices. (The term “smart card interface” is used generically herein to refer to any of a variety of devices for reading or writing such media.) A module 304 may be provided that includes a docking station 306 for receiving a portable device such as a hand-held computing device, communications device or media player. A module 308 may be provided that includes a biometric reader 310 such as a fingerprint reader. A module 312 may be provided that includes a data communications transceiver 314 such as a Bluetooth or infra-red transceiver. Not only may different detachable modules be provided, but the devices hosted on a module may be combined to produce a composite detachable module. The modules shown in the illustrations are provided by way of example only; the locations, shapes, numbers and orientations of the features shown thereon may be varied as appropriate and in accordance with the nature of their deployment. Keyboard module 102 may be equipped with alphanumeric and punctuation keys as suggested in FIG. 1. Alternatively, module 102 may be differently equipped and need not include user-input keys of any kind while other modules may provide user-input keys.

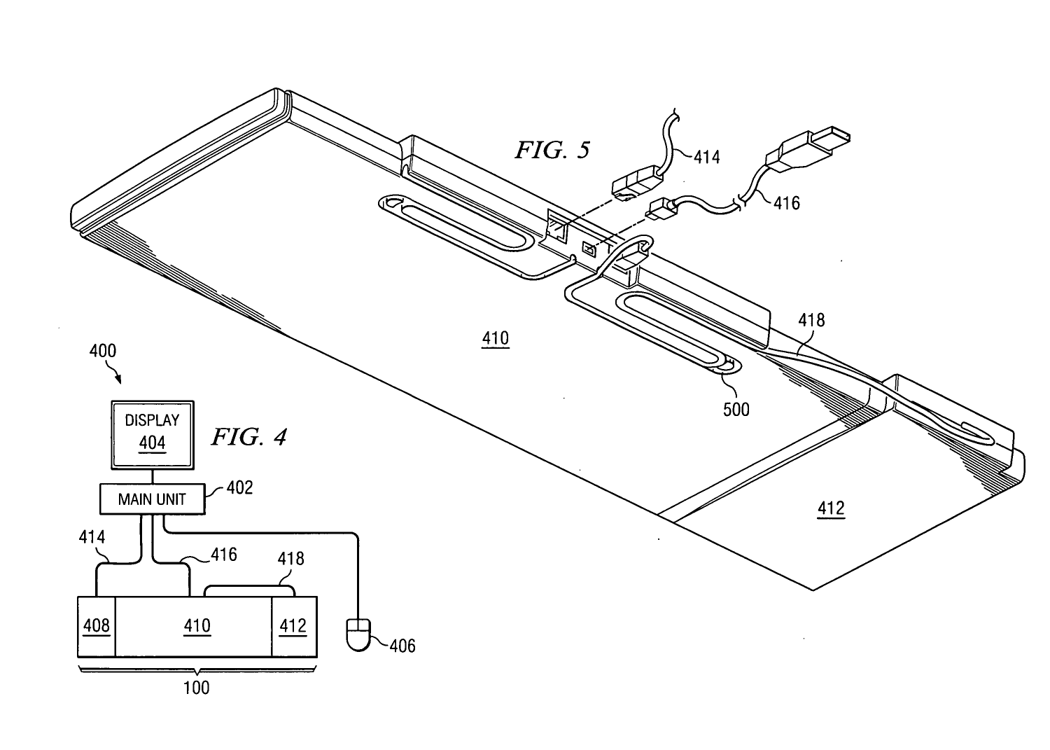

FIG. 4 illustrates an example computer system 400 incorporating a modular keyboard system such as keyboard system 100. Computer system 400 includes a main unit 402 that may house such components as a central processing unit, main memory and non-volatile storage. Computer system 400 also preferably includes a display device 404, either integral with main unit 402 or physically separate therefrom. Computer system 400 may also include a mouse 406. (The term “mouse” is used generically herein to refer to any of a variety of cursor-positioning devices.) Modular keyboard system 100 is shown in FIG. 4 as including three modules: modules 408, 410 and 412. In the embodiment shown, module 408 is electrically coupled to main unit 402 by cable 414, module 410 is electrically coupled to main unit 402 by cable 416, and modules 410 and 412 are electrically coupled to one another by cable 418. Any subset or superset of the module and cabling arrangements shown in FIG. 4 may be employed to incorporate keyboard system 100 into a computer system 400. For example, all of the detachable modules in keyboard system 100 may be coupled to module 410, and a single cable routed from module 410 to main unit 402. Or, as another example, all of the modules in keyboard system 100 may be coupled to main unit 402 with a separate cable. Cables 414, 416, 418 may be of any suitable type, and need not all be of the same type. For example, cable 414 may be terminated with an RJ-45 connector, while cable 418 may be terminated with an RJ-11 connector, and cable 416 may be terminated with a universal serial bus (“USB”) connector. Other combinations, permutations and connector types may also be employed. Moreover, in still further embodiments, any of the modules in keyboard system 100 may be coupled to one another or to main unit 402 wirelessly using any of several well-known technologies. Signals from one or more modules may also be combined and transmitted to main unit 402 using a single cable or communications channel according to techniques known in the art.

Referring now to FIG. 5, any module in modular keyboard system 100 may include a recess such as recess 500 for receiving and substantially securing a portion of a cable such as cable 418 that couples module 412 to module 410.

While the invention has been described in detail with reference to preferred embodiments thereof, the described embodiments have been presented by way of example and not by way of limitation. It will be understood by those skilled in the art that various changes may be made in the form and details of the described embodiments without deviating from the spirit and scope of the invention as defined by the appended claims.

What is claimed is:

1. A modular keyboard system, comprising:
a keyboard module having a left end and a right end; and
a detachable module configured to be coupled rigidly to at least one of the left and right ends of the keyboard module.

2. The modular keyboard system of claim 1, wherein:
the keyboard module comprises a first coupling feature at its left end or its right end; and
the detachable module comprises a left end and a right end, and a second coupling feature at its left end or its right end.

3. The modular keyboard system of claim 2, wherein:
one of the first and second coupling features comprises a boss having a head and a neck; and
the other of the first and second coupling features comprises a void for receiving the head of the boss and a protrusion for engaging the neck of the boss.

4. The modular keyboard system of claim 2:
further comprising a first length from a front to a back of the keyboard module and a second length from a front to a back of the detachable module; and wherein:
the first coupling feature extends along substantially the entire first length, and the second coupling feature extends along substantially the entire second length.

5. The modular keyboard system of claim 2, wherein:
the keyboard module comprises the first coupling feature at both its left and its right ends; and
the detachable module comprises the second coupling feature at both its left and its right ends.

6. The modular keyboard system of claim 3, wherein:
the second coupling feature is operable to deform elastically as the protrusion passes over the boss during engagement and disengagement of the detachable module with the keyboard module.

7. The modular keyboard system of claim 6, wherein:
the second coupling feature comprises molded plastic.

8. The modular keyboard system of claim 6, wherein:
at least one of the boss and the protrusion comprises a beveled or rounded surface to facilitate deformation of the second coupling feature during engagement and disengagement of the detachable module with the keyboard module.

9. The modular keyboard system of claim 1, wherein:
the detachable module comprises a numeric keypad.

10. The modular keyboard system of claim 1, wherein:
the detachable module comprises a smart card reader.

11. The modular keyboard system of claim 1, wherein:
the detachable module comprises a docking station.

12. The modular keyboard system of claim 1, wherein:
the detachable module comprises a biometric reader.

13. The modular keyboard system of claim 1, wherein:
the detachable module comprises a data communications transceiver.

14. The modular keyboard system of claim 1, wherein:
the keyboard module comprises alphanumeric and punctuation keys.

15. The modular keyboard system of claim 1, wherein:
the keyboard module and detachable module are configured to be electrically coupled to one another by a cable.

16. The modular keyboard system of claim 1, wherein:
the keyboard module and detachable module are configured for wireless communication with one another.

17. The modular keyboard system of claim 1, wherein:
at least one of the keyboard module and the detachable module is configured to be electrically coupled to a main unit of a computer by a cable.

18. The modular keyboard system of claim 1, wherein:
at least one of the keyboard module and the detachable module is configured for wireless communication with a main unit of a computer.

19. The modular keyboard system of claim 15, wherein at least one of the keyboard module and detachable module comprises:
a recess for receiving and substantially securing a portion of the cable.

20. The modular keyboard system of claim 15, wherein at least one of the keyboard module and detachable module comprises:
a first connector component operable to mate with a second connector component on the cable.

21. The modular keyboard system of claim 15, wherein the cable comprises an RJ-11 connector.

22. The modular keyboard system of claim 15, wherein the cable comprises an RJ-45 connector.

23. The modular keyboard system of claim 15, wherein the cable comprises a USB connector.

24. A modular keyboard system, comprising:
a first module having a left end and a right end;
a second module; and
means for rigidly coupling the second module either to the left end or to the right end of the first module;
wherein at least one of the first and second modules comprises a field of user-input keys.

25. A computer system, comprising:
a main unit;
a display;
a mouse; and
a modular keyboard system, the modular keyboard system comprising:
a first module having a left end and a right end; and
a second module configured to be coupled rigidly either to the left end or to the right end of the first module;
wherein at least one of the first and second modules comprises a field of user-input keys.

26. The computer system of claim 25, wherein:
at least one of the first and second modules is configured to be electrically coupled to the main unit by a cable.

27. The computer system of claim 25, wherein:
at least one of the first and second modules is configured for wireless data communication with the main unit.

28. The computer system of claim 25, wherein:
the first and second modules are configured to be electrically coupled to one another by a cable.

29. The computer system of claim 25, wherein:
the first and second modules are configured for wireless data communication with one another.
